(19) United States
(12) Patent Application Publication
(10) Pub. No.: US 2002/0003414 A1
(43) Pub. Date: Jan. 10, 2002

(54) Control method for saving power

(75) Inventor: Yoshiharu Kuramoto, Aichi (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: Nisshinbo Industries, Inc., Tokyo (JP)

(21) Appl. No.: 09/897,113

(22) Filed: Jul. 3, 2001

(30) Foreign Application Priority Data
Jul. 7, 2000 (JP) 2000-206396

(51) Int. Cl. G05B 11/01

(52) U.S. Cl. 318/560

(57) ABSTRACT

To present a control method for saving power capable of saving power in such a machine as a turret punch press, and preventing generation of noise due to operation of main motor of hydraulic unit while processing job is not done, being applied in such a machine as a metal cutting machine designed to be driven by feeding electric power to a main motor and servo amplifiers of individual axes, with the electric power supplied in both main motor and servo amplifiers of individual axes, it is designed to cut off power supply circuits to the main motor and servo amplifiers of individual axes, on the condition that the machine is not operated for processing and that the no-operation state continues for a prescribed time.

### BACKGROUND OF THE INVENTION

1. Field of the Invention

The present invention relates to an efficient control method for saving power capable of operating a machine without useless supply of electric power to motors and other drive sources when operating, for example, turret punch press or similar machine.

2. Description of the Related Art

In the case of turret punch press having a plurality of tools, metal processing machine, and machine tool, once becoming ready, or in a state where power has been turned on, the machine operates unless its ready state is turned off. Whether operating or not, for example, in the turret punch press, the power source is always applied into the main motor of the hydraulic unit, and into the servo amplifiers for servo motors of X, Y, T, and C axes for operating the turret, work table, work clamp, etc.

Therefore, in such turret punch press, once becoming ready, the main motor of the hydraulic unit continues to rotate, and noise does not cease, and this noise is annoying and irritating for the machine operator.

To save the power consumption and liberate from noise, therefore, the ready state is turned off while the machine is out of service, but when using again, the on/off button of the ready switch must be turned on every time, and this is equally bothersome. This point is the same not only in the turret punch press, but also in other metal processing machine or machine tool.

In the light of the problems of the prior art, it is hence an object of the invention to present a control method for saving power capable of saving power consumption in turret punch press or other similar machine, and also preventing generation of noise due to operation of main motor of hydraulic unit or the like during the rest period of processing work.

### SUMMARY OF THE INVENTION

To achieve the object, the invention is applied in such a machine as a metal cutting machine designed to be driven by feeding electric power to a main motor and servo amplifiers of individual axes, with the electric power supplied in both main motor and servo amplifiers of individual axes, and is characterized by cutting off power supply circuits to the main motor and servo amplifiers of individual axes, on the condition that the machine is not operated for processing and that the no-operation state continues for a prescribed time.

### BRIEF DESCRIPTION OF THE DRAWING

FIG. 1 is a flowchart of an example of a control method of the invention.

### DESCRIPTION OF THE PREFERRED EMBODIMENT

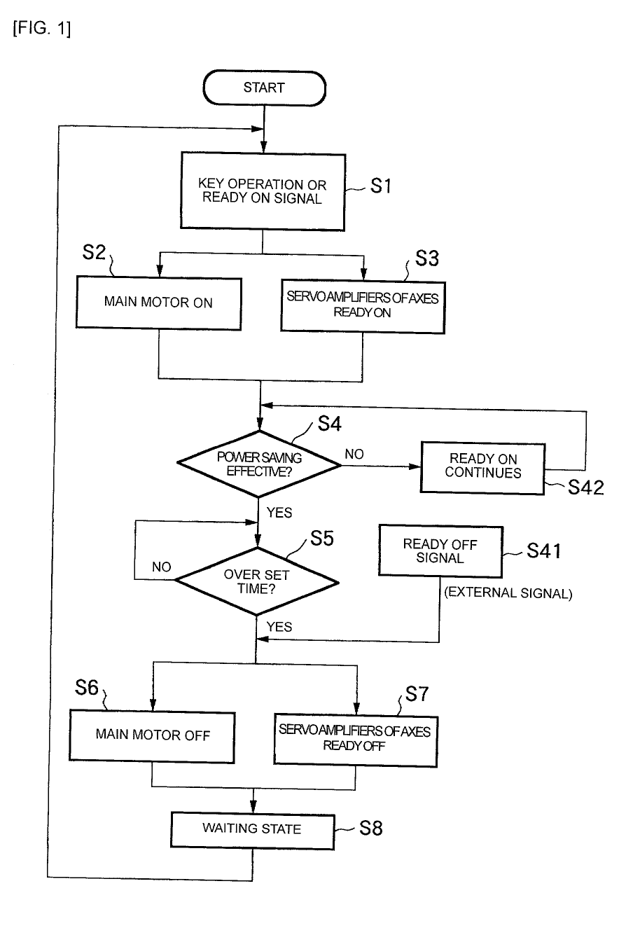

A preferred embodiment of the invention is described below. FIG. 1 is a control flowchart for carrying out an example of a control method of the invention.

In the illustrated control flow, when control is started by the method of the invention, at step S1, a ready ON signal is formed by key operation or the like, and by this ready ON signal, at steps S2 and S3, for example, electric power of the power source is connected to the main motor of the hydraulic unit and servo amplifiers of axes, so that it is ready to start operation anytime. Therefore, when the machine is put in this state, it is possible to process as desired whenever by driving the motor and servo motors.

In the invention, in this ready state, or after executing desired processing by the machine, at step S4, it is judged whether the motor and amplifiers should be kept in the state of steps S2 and S3, that is, in ready state, according to the question “Power saving effective?”. At step S4, to judge “Power saving effective?” for example, it is detected whether the main motor and servo motors are being driven for the purpose of processing or not, and it is judged No if driven, and Yes if not driven.

If the power saving is judged to be effective, at step S5, it is judged if a prescribed time has passed or not, and when reaching the prescribed time, at steps S6 and S7, the ready state of the motor and amplifiers, that is, the power source power connection state is turned off to get into a waiting state at step S8. In the waiting state at step S8, if any operation is done at the machine side, for example, when key operation at step S1 is done, the machine is changed to a ready ON state.

On the other hand, if “Power saving effective?” is judged No at step S4, the ready ON state at step S42 continues. Or if a ready OFF signal is entered from outside at step S41, the machine is put in a waiting state at step S8 by way of step S6 and step S7.

Hitherto, once the machine is put in ready state, unless this ready state is turned off, whether the machine is processing or operating or not, the power is always applied into the main motor of the hydraulic unit and into the servo amplifiers of axes, and not only useless power was consumed, but also noise was released all the time, but according to the control method of the invention, while the machine is in ready state, the active state of the motor and amplifiers is always checked at step S4, and as far as the motor and amplifiers are in active state (driven state at the time of processing), the power saving control by the method of the invention is not put in effect, and when a ready OFF signal is supplied from outside in stationary route, or when the motor and amplifiers are not operated, the duration of inactive state is measured from step S4 to step S5, and when the measured duration exceeds a prescribed time, supply of power is cut off, and hence useless power is not consumed and noise is eliminated, and this is extremely effective as control method for saving power.

Having such effects and benefit, the invention is particularly suitable as control method for saving power in turret punch press, metal processing machine, and machine tool, and especially in a machine having a plurality of hydraulic units and motors, or a servo control system thereof.

What is claimed is:

1. A control method for saving power in such a machine as a metal cutting machine designed to be driven by feeding electric power to a main motor and servo amplifiers of individual axes, with the electric power supplied in the main motor and the servo amplifiers of individual axes, wherein power supply circuits to the main motor and servo amplifiers of individual axes are cut off, on the condition that the machine is not operated for processing and that the no-operation state continues for a prescribed time.
